(19) United States
(12) Patent Application Publication
(10) Pub. No.: US 2021/0034318 A1
(43) Pub. Date: Feb. 4, 2021

(54) SHARED VOLUME COMPUTING ARCHITECTURE OF A VIRTUAL REALITY ENVIRONMENT AND RELATED SYSTEMS AND METHODS

(71) Applicant: vSpatial, Inc., Provo, UT (US)

(72) Inventors: John Goodman, Springville, UT (US); David Levon Swanson, Provo, UT (US); Thomas Keene, Provo, UT (US)

(21) Appl. No.: 16/944,919

(22) Filed: Jul. 31, 2020

Related U.S. Application Data
(60) Provisional application No. 62/881,160, filed on Jul. 31, 2019.

(51) Int. Cl. G06F 3/14; G06F 3/0481

(52) U.S. Cl. CPC G06F 3/1454; G06F 3/013; G06F 3/04815

(57) ABSTRACT

Virtual reality engines are discussed that configured to control, at a physical display system, display a shared volume in a virtual workspace, display a shared virtual work object at the virtual workspace, and capture expressive actions. Such virtual reality engine and a display system may be included in a shared workspace computing system.

### CROSS-REFERENCE TO RELATED APPLICATION

This application claims the benefit under 35 U.S.C. § 119(e) of U.S. Provisional Patent Application Ser. No. 62/881,160, filed Jul. 31, 2019, the disclosure of which is hereby incorporated herein in its entirety by this reference.

### TECHNICAL FIELD

The embodiments of the present disclosure generally relate to interfaces that may be used in virtual reality environments, and more specifically, in certain embodiments, directionally oriented keyboards.

### BACKGROUND

Conventional virtual reality environments may be used to mimic the physical objects, functions and behavior of conventional a physical computer workspace. Some virtual reality engines use different systems to interface with a virtual environment, for example, gloves, wands, and thumbsticks. The particular interface is used with the virtual workspace that is generated by the virtual reality engine.

Some conventional virtual reality interfaces generate virtual hands for interacting with simulated work-objects (e.g., a document, presentation, 3-D model, etc.) in the virtual reality environment, and a user may operate the virtual hands by moving his/her physical hands, sometimes with the assistance of position and motion tracking hardware (e.g., gloves, cameras, etc.).

### BRIEF DESCRIPTION OF THE DRAWINGS

The purpose and advantages of the embodiments of the disclosure will be apparent to one of ordinary skill in the art from the summary in conjunction with the detailed description and appended drawings that follow. The patent or application file contains at least one drawing executed in color. Copies of this patent or patent application publication with color drawing(s) will be provided by the Office upon request and payment of the necessary fee:

FIGS. 1A to 1G show an example sequence of sharing expressive actions during a shared workspace session, in accordance with one or more embodiments of the disclosure.

FIG. 2 shows a shared workspace computing system, in accordance with one or more embodiments of the disclosure.

FIG. 3 shows a shared volume activation process, in accordance with one or more embodiments of the disclosure.

FIG. 4 shows a shared workspace session management process performed by a shared workspace session service, in accordance with one or more embodiments of the disclosure.

FIG. 5 shows display of virtual hands in a shared volume and presenter shared volume, in accordance with one or more embodiments of the disclosure.

FIG. 6A shows an example of shared volumes in front of shared screen where a virtual hand of a presenter and a participant are displayed in the shared volumes.

FIG. 6B shows an example of a shared volume where an object is shared within the shared volume instead of, or in addition to, virtual hands.

FIG. 7 shows an example of a carousel with shared volume at a first position and a second position after moving a presenter's carousel, in accordance with one or more embodiments of a disclosure.

FIG. 8 shows examples of various shapes and dimensions of the shared volume.

FIGS. 9A and 9B show a hand vs. a gaze pointer that is provided to a shared volume, in accordance with one or more embodiments of the disclosure.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure. The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, etc. Furthermore, the functions, features and methods disclosed herein may be implemented, in whole or in part, in hardware, software, or both. If implemented in software, functions or performing features, functions and methods discussed herein, in whole or in part, may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Sometimes a user will share his virtual workspace with one or more other users, whereby at least some part of his virtual workspace is visible at the virtual workspace of the other users. The virtual workspace that is visible at other virtual workspaces may be referred to herein as a “shared workspace” or “active workspace.” A virtual workspace at which a shared workspace is visible may be referred to herein as a “participating workspace” or a “participant workspace.” When a shared workspace is shared with participating workspaces, that may be referred to herein as a “workspace sharing session.” The use of the term “visible” is not intended to require that a shared workspace actually be visible, and includes shared workspaces that are available to be viewed at one or more participating workspaces, whether not actually visible.

In conventional virtual workspaces known to the inventors of this disclosure, a user may use a virtual keyboard and/or virtual mouse to interact with virtual application objects in a virtual workspace, in a “point and click” manner. Examples of virtual application objects (which may also be characterized herein as “virtual workspace objects” or just “workspace objects”) include, without limitation, representations of screens, hardware (e.g., keyboard, mouse), models, and other objects; and may also include graphical user interfaces (GUI(s)) and content thereof for word processing applications, presentation applications, spread sheet applications, computer assisted design (CAD) applications, and more. Content and information about how to format content for display at a GUI may typically be stored in one or more electronic files that may be accessed later.

In some conventional workspace sharing sessions known to the inventors of this disclosure, a cursor and/or mouse pointer controlled by the user of the shared workspace may be visible at a participating workspace. In other conventional workspace sharing sessions known to the inventors of this disclosure, all hand motions and hand positions may be captured and displayed at a shared workspace and participating workspaces.

The inventors of this disclosure appreciate a need for a virtual workspace that enables a user to share a subset of his hand poses, hand motions, and hand positions that are expressive, i.e., that express information related to a shared workspace to users of participating workspace. The expressive hand motions and hand positions may be characterized in this disclosure as “expressive actions.” By way of non-limiting example, expressive actions include pose(s) such as pointing, open palms, and closed fist, and such poses may be combined with movement (e.g., rotation, changes in position relative to a workspace object, etc.) to create gestures such as underlining, counting with fingers, sign language, and more. By way of example and not limitation, expressive actions may be intended to convey information, provide directions, or call attention, without limitation.

As used herein, “virtual reality” and its abbreviation, “VR,” means a computer-generated simulation of a three-dimensional image or environment that may be interacted with in a seemingly real or physical way by a person using interface devices, such as a headset with a display screen, gloves, and/or a thumbstick device, without limitation. VR, and more specifically a virtual reality system for generating VR, may incorporate devices for visual, auditory, and sensory elements. Interface devices may incorporate sensors for gathering information about how a user interacts with a VR simulation, including one or more of head movement, eye movement, arm and hand movement, body position, body temperature, without limitation. A virtual reality environment may simulate physical things, for example, a person's hands, head, etc., including physical things about which information is captured using, for example, one of the aforementioned interface devices.

As used herein, “virtual reality” and its abbreviation, “VR,” also includes mixed-reality (which includes augmented-reality) simulations of three-dimensional images that “overlay” the real world. Such mixed-reality simulations may be interacted with, again, in a seemingly real or physical way by a person using interface devices, and/or using their body parts (e.g., head, hands, arms, legs, without limitation) where movement is captured by cameras or other sensors associated with the headset or glasses that provide the simulated overlay of the mixed-reality. Non-limiting examples of virtual reality display systems include headsets, glasses, a display (e.g., of a phone, tablet, television, computer monitor, without limitation) viewed with image warping lenses (e.g., biconvex lenses, plano-convex lenses, without limitation) and sometimes incorporating a head mounting accessory for an immersive experience.

One or more embodiments of this disclosure relate to a computing architecture for a shared workspace that enables sharing of expressive actions to and among participating workspaces, including a shared workspace within a virtual reality environment. In one embodiment, a shared workspace has one or more shared volumes configured such that, when active and a user's simulated hands are present within a shared volume, expressive actions of the simulated hands may be displayed at participating workspaces. So, one or more embodiments of the disclosure relate, generally, to expressive sharing in a workspace sharing session.

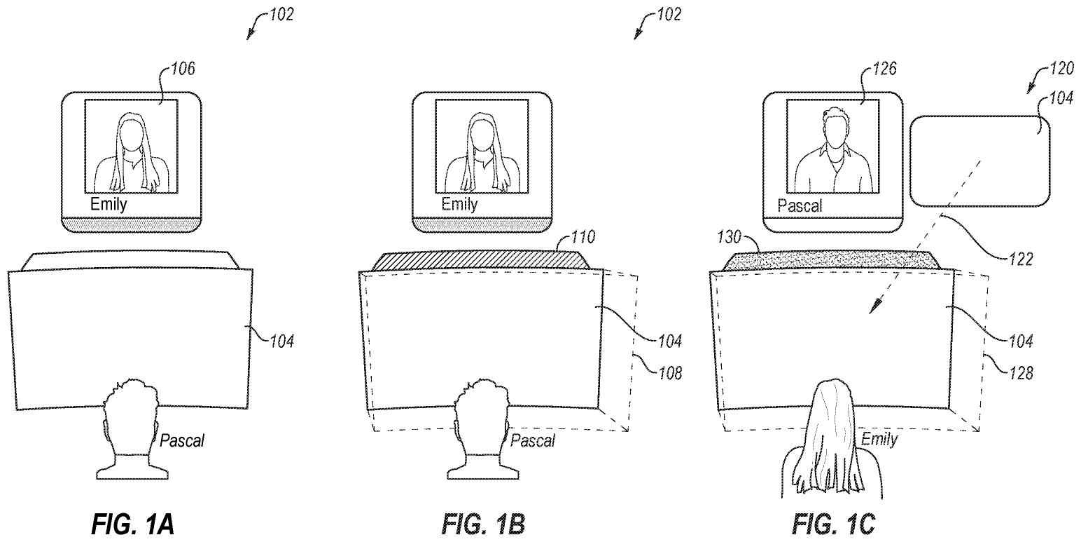

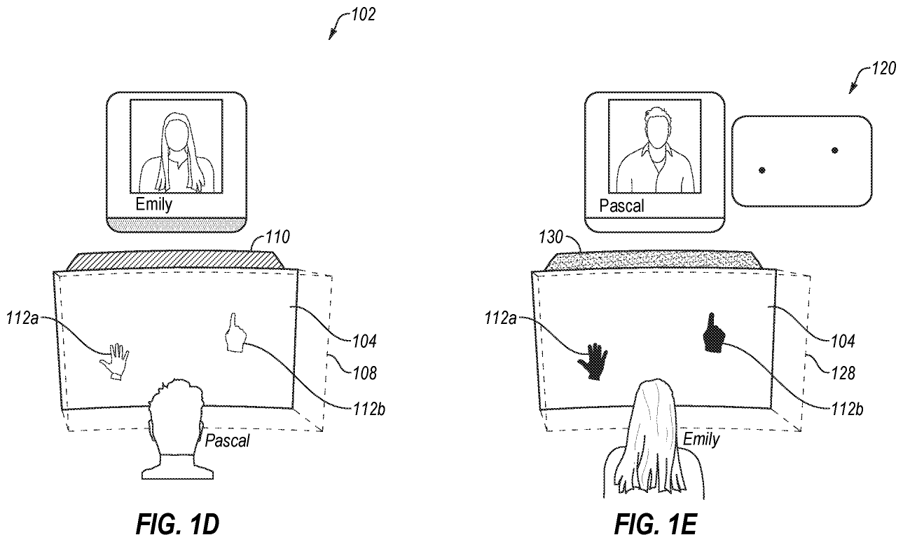

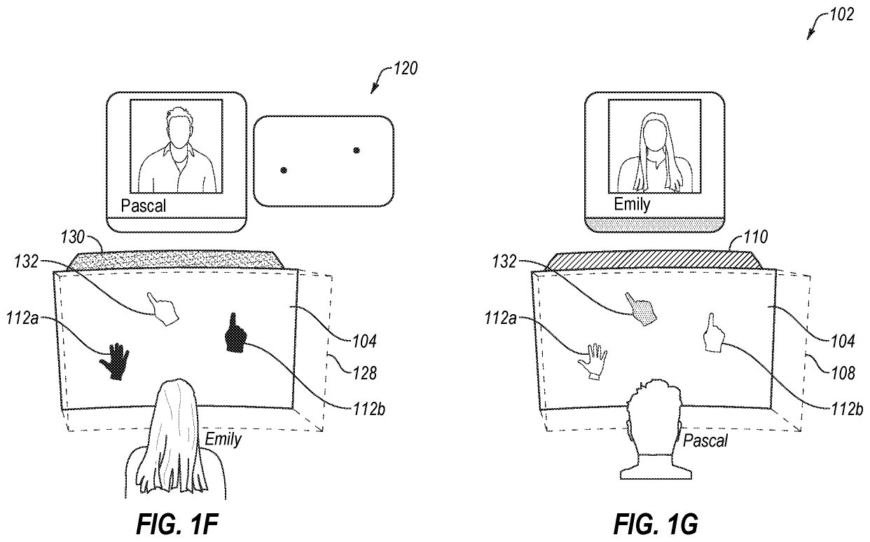

FIGS. 1A to 1G depict a specific non-limiting example sequence of sharing expressive actions during a shared workspace session, in accordance with one or more embodiments of the disclosure. FIG. 1A shows shared workspace 102 at which a shared screen 104 is displayed. An optional participant profile 106 is displayed at the shared workspace 102, here, participant profile 106 is a picture of a person, but, by way of non-limiting example, a participant profile 106 may include a video feed, an avatar, and an icon, information about a participant, and combinations of the same.

FIG. 1B shows the shared workspace 102 after a shared volume 108 has been activated. The shared volume 108 is a volumetric region in front of the shared screen 104. Here, shared volume 108 is shown as a cuboid, but it any suitable shape may be selected including a cube, sphere, cylinder, cone, prism, pyramid, frustum, and combinations of the same. By way of example and not limitation, a particular shape and dimensions of a shared volume 108 may be selected based on a shape of a workspace object, such as screen 104, which is substantially rectangular.

When shared volume 108 is active, a “hidden” user interface (HUI) 110 is present behind the shared screen 104.

FIG. 1C shows participant workspace 120 during the shared workspace session, in accordance with one or more embodiments of the disclosure. Initially, when a shared workspace session is initiated then shared screen 104 is displayed at the participant workspace 120 next to a presenter profile 126. Shared screen 104 may be “pulled” or “added” 122 to a participant's carousel, which is a set of one or more workspace objects that are part of a user's workspace. When shared screen 104 is added to the participant's carousel, participant shared volume 128 is activated in front of shared screen 104 at least in part because shared volume 108 is active at shared workspace 102. When participant shared volume 128 is active, a hidden user interface (HUI) 130 may be present behind the shared screen 104.

FIG. 1D shows virtual left and right hands 112a and 112b, controlled by a presenter, present within shared volume 108 of workspace 102. The virtual hands 112a, 112b are displayed within the shared volume 108, including expressive actions, in this example, hand gestures. In one or more embodiments, the position and expressions of the virtual hands 112a, 112b are displayed responsive to a presenter's position and movement of their hands (or what is assumed by the system to be hands if a user does not have hands or uses an object to represent hands). Notably, a presenter may control expressive actions of virtual hands 112a, 112b relative to shared screen 104. When virtual hands 112a, 112b are present within shared volume 108, they may be characterized herein as “shared” virtual hands 112a, 112b.

Presenter HUI 110 may capture information about the virtual hands 112a, 112b and shared screen 104, including expressive actions associated with virtual hands 112a, 112b relative to the shared screen 104, for example, relative to content at the shared screen 104 a position (e.g., x-y coordinate) at the shared screen 104, and more. In one or more embodiments, the information may be captured in real-time, or near real-time.

FIG. 1D shows participant workspace 102 when virtual hands 112a, 112b are present in shared volume 108. Shared virtual hands 112a, 112b are displayed within participant shared volume 128. In one or more embodiments, shared virtual hands 112a, 112b are displayed with the expressive actions captured in shared volume 108 relative to shared screen 104.

FIG. 1E shows participant workspace 120 when virtual hands 112a, 112b are present within participant shared volume 128. When present within participant shared volume 128, virtual hands 112a, 112b may be characterized as “shared” virtual hands or shared virtual hands of the presenter. FIG. 1F shows participant virtual hand 132 displayed within the participant shared volume 128 along with virtual hands 112a, 112b. Participant HUI 130 may capture information about the participant virtual hand 132, for example, information about expressive actions relative to shared screen 104 and shared virtual hand 112a, 112b.

FIG. 1G shows shared workspace 102 when shared participant virtual hand 132 is displayed within shared volume 108 along with virtual hands 112a, 112b. When present within shared volume 108, participant virtual hand 132 may be characterized as a “shared” participant virtual hand.

Participant virtual hand 132 is displayed within the participant shared volume 128 along with virtual hands 112a, 112b. In one or more embodiments, participant HUI 130 may capture information about the participant virtual hand 132, for example, information about expressive actions relative to shared screen 104 and shared virtual hand 112a, 112b. HUI 130 may capture information only about expressive actions or information that includes expressive action information or that may be used to identify and derive expressive actions. As non-limiting examples, HUI 130 may capture expressive action information relative to a workspace, shared volume, and/or shared workspace object.

In one or more embodiments, shared virtual hands, such as shared virtual hands 112a, 112b and shared participant virtual hand 132, may only be displayed within a corresponding shared volume. For example, at shared workspace 102, shared participant virtual hand 132 may only be displayed within shared volume 108, and at participant workspace 120, shared virtual hands 112a, 112b may only be displayed within shared volume 128. By way of further example, a shared virtual hand may be displayed when a corresponding virtual hand (e.g., participant virtual hand or presenter virtual hand) is present within a shared volume and then, only displayed within the shared volume. As a non-limiting example, by constraining interaction to within the shared volume, this ensure interaction is meaningful and intentional, to a reasonable degree.

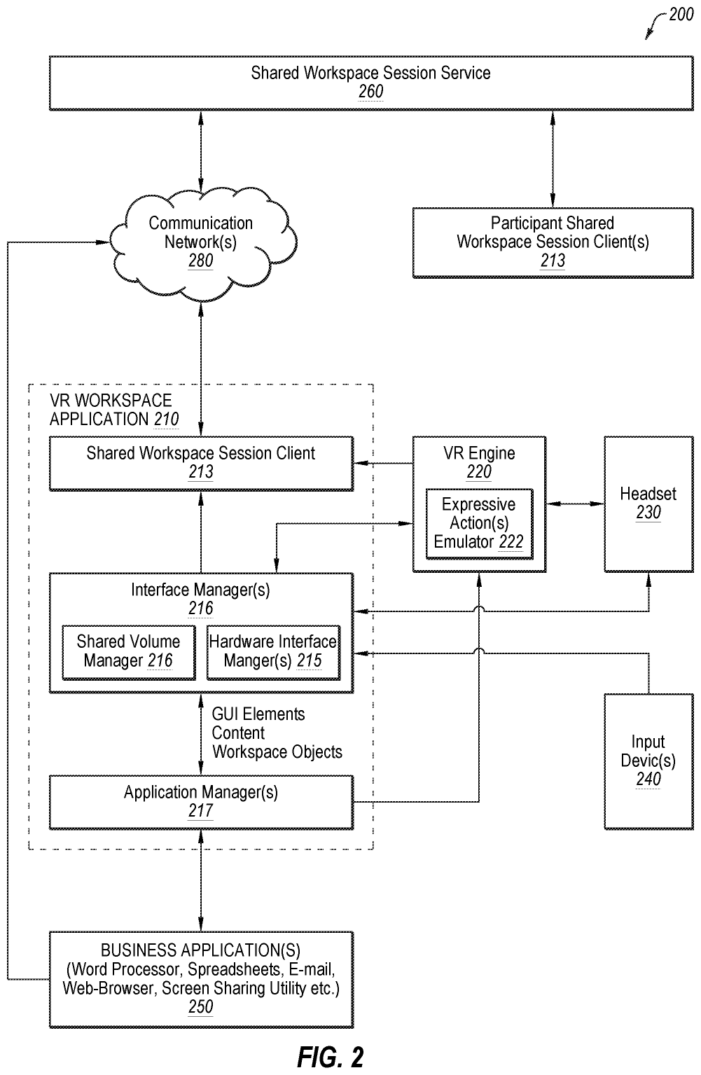

FIG. 2 shows a shared workspace computing system 200, in accordance with one or more embodiments of the disclosure. In one or more embodiments, a workspace computing system 200 may include a VR workspace application 210, a VR engine 220, headset 230, an input device 240, and one or more business applications 250, which, may operate together to provide a VR workspace to a user. VR workspace application 210 may be configured to send communication messages, and receive communication messages, over communication network(s) 280 by way of one or more shared workspace session clients 213. In particular, VR workspace application 210 may be configured to communicate with shared workspace session service 260. Shared workspace session service 260 may be configured to communicate with one or more shared workspace session clients, including without limitation shared workspace session client 213 and participant shared workspace session client 270.

While a virtual workspace enabled by VR workspace application 210 may be referred to in one or more examples as a shared workspace, the architecture of VR workspace application 210 may be configured to enable both shared and participant workspaces, depending on a specific shared workspace session.

VR workspace application 210 may be configured to provide a VR workspace to a user of headset 230. Such a VR workspace may provide one or more of a virtual computer, virtual monitors/virtual screens, virtual keyboards and interface devices, objects for manipulation, virtual meeting rooms, and more. VR workspace application 210 may enable a user to call (and run various business applications 250. By way of example and not limitation, business applications 250 may include applications for word processing, spreadsheets, presentations, web-browsing, e-mail, and more.

VR workspace application 210 may include a shared workspace session client 213, interface managers 216, and application managers 217. Interface managers 216 may be configured to manage inputs from a variety of input devices, including VR gloves, keyboards, image capture devices, etc. Interface managers 216 may also be configured to manage inputs from or associated with virtual input objects, such as virtual keyboards, virtual pointing devices, and shared volumes.

In one or more embodiments, one or more interface managers 216 may be device drivers associated with input devices 240, such as VR gloves or image capture devices. Such a driver may include application programming interfaces (APIs) that may be called, for example, by a virtual reality engine. In yet other embodiments, one or more interface managers 216 may be incorporated into an operating system (OS), such as a WINDOWS® based OS, a MAC® OS, a UNIX based OS, an ANDROID® based OS, or another OS. In yet other embodiments, one or more interface managers 216 may be incorporated into a VR overlay application.

In one or more embodiments, interface manager 216 may include shared volume manager 214 and hardware interface manager 215. Hardware interface manger(s) 215 may be configured to manage and store definitions associated with, among other things, VR gloves. The definitions may include instructions useable by VR engine 220 to display rotation, pose, movement, and/or position of a virtual hand responsive to input information indicative of physical rotation, pose, movement, and/or position of a physical VR glove. The hardware interface manager 215 may be configured to provide one or more instructions as well as input information to VR engine 220 responsive to input information received from input devices 240.

In one or more embodiments, shared volume manager 214 may capture expressive action instructions provided by hardware interface manager 215 to VR engine 220. These expressive action instructions may be combined with or enhanced using expressive action information captured by a HUI, as a non-limiting example, a pointing gesture captured from an instruction generated by hardware interface manager 215 may be combined with directional information indicating a virtual direction within a shared volume that a virtual finger pointed.

In one or more embodiments, shared volume manager 214 may be configured to receive input information from input devices 240, receive workspace object information from application managers 217, determine if input information corresponds to a shared volume of a shared workspace (e.g., shared volume 108 of FIG. 1B), send position information relative to one or more workspace objects (e.g., shared screen 104 of FIG. 1B) to shared workspace session client 213, and coordinate for expressive action information to be provided to shared workspace session client 213.

In one or more embodiments, expressive action emulator 222 may be configured to receive input information and to provide expressive action information. Expressive action emulator 222 may be configured to generate instructions usable by a VR engine (such as VR engine 220) associated with a shared workspace or a participant workspace to simulate expressive actions by virtual hands. In one or more embodiments, expressive action emulator 222 may be part of VR engine 220. In one or more embodiments, expressive action emulator 222 may be part of the VR workspace application 210, for example, part of shared volume manager 214.

Business application manager(s) 250 may be configured to manage various business application(s) 250 executing in conjunction with VR workspace application 210, and that a user may interact with via a shared workspace, including calling the applications and using the applications.

VR workspace application 210 may be configured to operate in conjunction with VR engine 220. VR engine 220 may be configured to provide the graphics and other simulation processing to simulate a virtual space a headset 230. Various headsets 230 may be used with embodiments of the disclosure, for example, the HTC VIBE®, OCULUS RIFT®, SONY PLAYSTATION® VR®, SAMSUNG GEAR® VR®, and GOOGLE DAYDREAM® VIEW. It is also specifically contemplated that may be use with mixed-reality headsets (or headsets operating in a mixed-reality mode), for example, MICROSOFT HOLO-LENSE®.

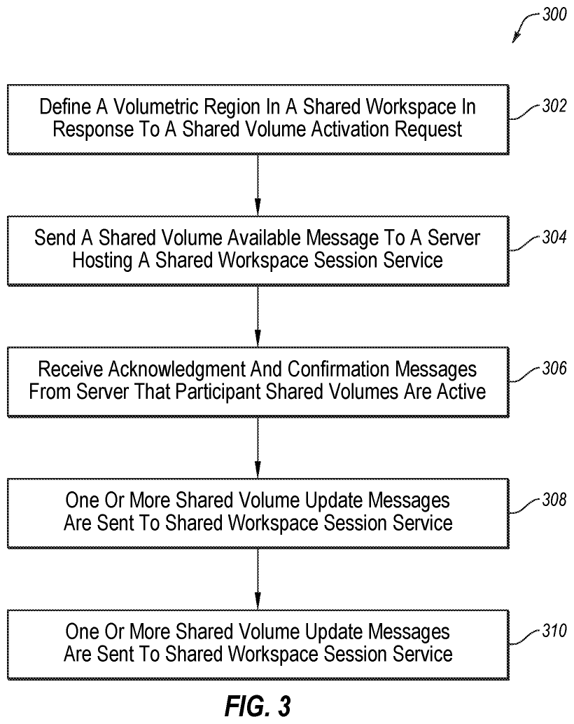

FIG. 3 shows a shared volume activation process 300, in accordance with one or more embodiments of the disclosure. In operation 302, process 300 defines a volumetric region in a shared workspace in response to a shared volume activation request. The volumetric region is defined in a workable region of the shared workspace. The workable region may be defined relative to a workspace object and a user (e.g., a viewpoint of a virtual user, without limitation). For example, a workable region may be the volumetric region between a user's virtual position and a position of the workspace object, within the user's workspace. A shared volume corresponding to the defined volumetric region may be visually indicated at the user's workspace, for example, partially outlined. A hidden user interface (HUI) may be activated, and the HUI may be associated with the shared volume. In operation 304, process 300 sends a shared volume available message to a server hosting a shared workspace session service. The message may include one or more of a session ID, a work object ID, and participant IDs. In one or more embodiments, a business application 250 that manages sharing of the work object(s) (e.g., a screen share application) may provide the participant IDs to shared workspace session client 213. In operation 306, process 300 receives acknowledgment message(s) from the shared workspace session service 260. In one or more embodiments, the acknowledgement messages may be configured to indicate that one or more participant have pulled shared work objects into their carousel and/or have shared volumes that are active. Moreover, the acknowledgement messages may be configured to indicate that no participants have pulled the shared work objects into their carousel and/or have shared volumes that are active.

While the shared workspace session is active, the shared workspace session client 213 may receive several acknowledgement messages from the shared workspace session service 260, if participants add and remove work objects and participant shared volumes to and from their carousel.

When a user uses the shared volume, in operation 308, process 300 sends one or more shared volume update messages to shared workspace session service 260. In one or more embodiments, the update messages may be configured to indicate locations of presenter's virtual hands in the shared volume and expressive actions associated with the virtual hands. In one or more embodiments, update messages may include one or more of a shared workspace session ID, a workspace object ID, one or more virtual hand locations relative to a shared volume and/or relative to a workspace object, and expressive action instructions associated with one or more of the virtual hand locations.

If a participant has a shared volume associated with the shared workspace session, then in operation 310, process 300 receives (e.g., at the shared workspace session client 213, without limitation) one or more participant shared volume update messages that are configured to indicate the location of a participant's virtual hands and expressive actions associated with those virtual hands. In one or more embodiments, the participant shared volume update may include one or more of a shared workspace session ID, workspace object ID, one or more virtual hand locations relative to a shared volume and/or relative to a workspace object, and expressive action instructions associated with one or more of the virtual hand locations. In one or more embodiments, the shared workspace session client 213 may be configured to parse the participant shared volume update message, extract the location information and expressive action instructions, and provide the parsed information and/or instructions to the VR engine 220 and the expressive action emulator 222. The VR engine 220 and expressive action emulator 222 may be configured to control display of participant virtual hands at the presenter's virtual workspace in the shared volume in response to the location information and expressive action instructions. As a non-limiting example, expressive action instructions may specify an expressive action in a general sense (e.g., perform a point gesture at location x, perform stop palm gesture, perform thumbs up gesture, perform underlining gesture, performing an encircling gesture, without limitation), or specific elements of gestures (e.g., make first and extend a finger in direction of location x; hand open extend toward direction x; hand open and palm facing viewer; make first and extend first finger, second finger, third finger, without limitation). In some cases, participants in a shared workspace session may employ different VR technology and so it is specifically contemplated by this disclosure that interfaces may be provided at shared workspace computing system 200 (e.g., at workspace application 210 or VR engine 220, without limitation) to convert expressive action instructions from and to various formats.

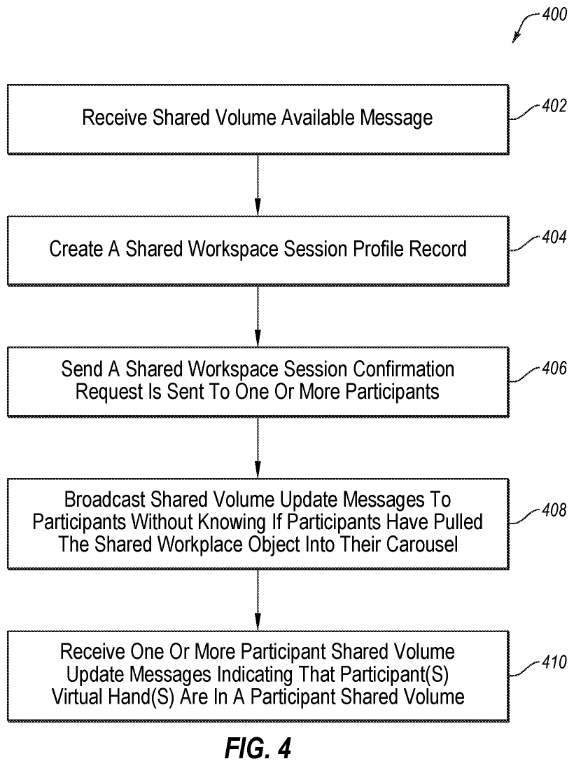

FIG. 4 shows a shared workspace session management process 400 performed by a shared workspace session service, in accordance with one or more embodiments of the disclosure. In operation 402, the shared workspace session services receives a shared volume available message, typically from the shared workspace session client of a presenter. In operation 404, a shared workspace session profile record is created that includes session ID, presenter ID, and participant IDs. In some embodiments the shared workspace session service 260 may generate the session ID and send it back to the shared workspace session client 213 that sent the shared volume available message. Multiple IDs may be stored because the shared workspace session service 260 may be configured to manage one to many shared workspace sessions for a presenter (consecutively and simultaneously), and may manage shared workspace sessions for many presenters (consecutively and simultaneously). In operation 408, a shared workspace session confirmation request is sent to one or more participants. In one or more embodiments, the participants may be identified in the shared volume available message.

In operation 408, the shared workspace session service may broadcast shared volume update messages to participants. In one or more embodiments, the shared workspace session service 260 may broadcast the update messages without knowing if participants have pulled the shared workspace object into their carousel. The broadcast messages may be configured to communicate location information about the presenter's virtual hands and associated expressive actions. The content of the broadcast messages may include a shared workspace session ID, a workspace object ID, one or more virtual hand locations relative to a workspace object, and expressive action instructions associated with the virtual hand locations.

In another embodiment, the shared workspace session service 260 may broadcast shared volume update messages to participants for whom there is a record of a confirmation message that a participant pulled a shared workspace object into their carousel.

In operation 410, the shared workspace session service 260 may receive one or more participant shared volume update messages indicating that participant(s) virtual hand(s) are in a participant shared volume, and send those messages to shared workspace session client 213. Participant shared volume update request message may include a workspace session ID, a workspace object ID, virtual hand locations, expressive actions associated with the virtual hand locations.

A shared volume expressive action may be displayed at a shared volume (participant or presenter). Location and expressive actions are determined responsive to location information and expressive action instructions. In one embodiment, the expressive action instructions may comprise identifiers for known expressions at the expressive action emulator. In one embodiment, the expressive action instructions may include operational instructions executable by the expressive action emulator 222 for display of expressive actions.

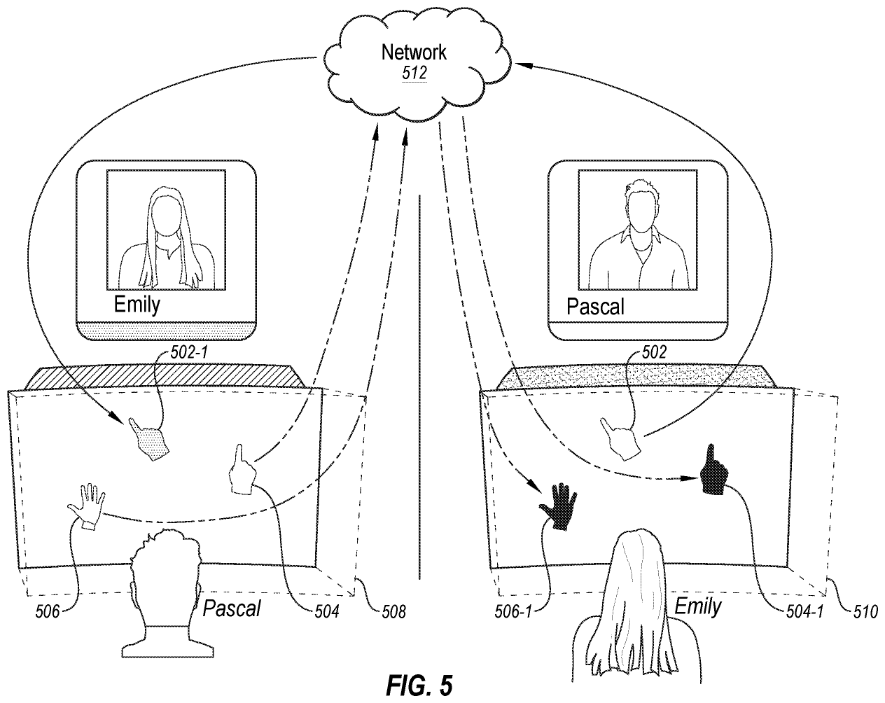

FIG. 5 shows a specific non-limiting example of display of virtual hands in a participant shared volume and presenter shared volume, in accordance with one or more embodiments of the disclosure. Presenter and participant are part of a shared workspace session via network 512. Presenter virtual hands 506 and 504 having expressive actions (pointing and open hand) are displayed at shared volume 508 and displayed as shared virtual hands 506-1 and 504-1 having captured expressive actions (pointing finger and open hand) at shared volume 510. Likewise participant virtual hand 502 having expressive actions (pointing finger) is displayed at shared volume 510 and displayed as shared virtual hand 502-1 having expressive actions (pointing finger) at shared volume 508.

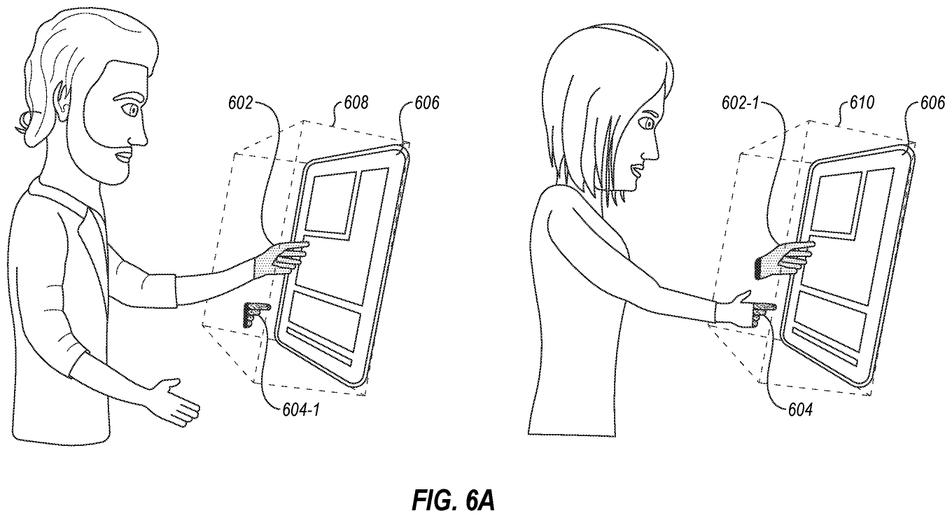

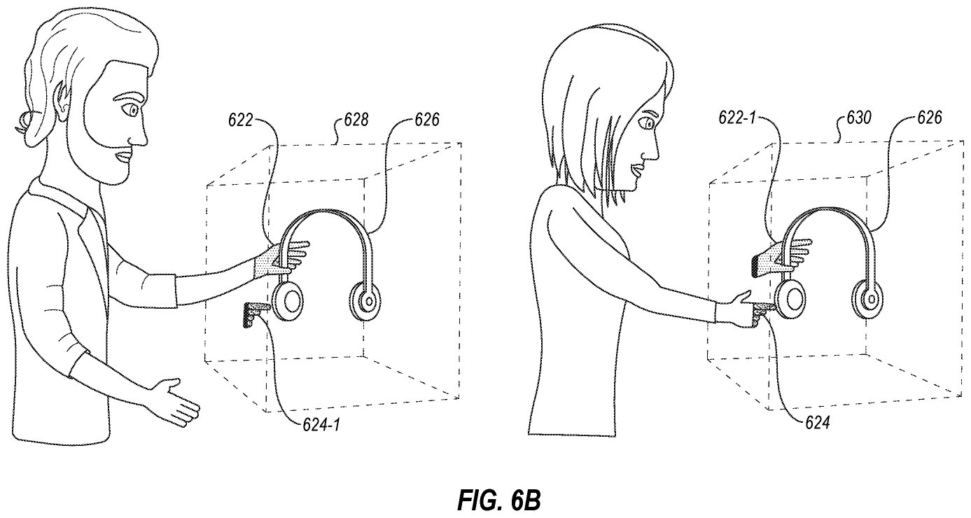

FIG. 6A shows a specific non-limiting example of display of shared volumes 608 and 610 in front of shared screen 60 where a virtual hand 602 of a presenter and a portion of a virtual hand 604 of a participant are displayed in the shared volumes of the participant and presenter, respectively, as shared virtual hand 602-1 and 604-1.

FIG. 6B shows a specific non-limiting example of shared volumes 628 and 630 of a shared workspace where a workspace object 626 is shared within the shared volumes 628 and 630, instead of, or in addition to, virtual hands 622 and 624 and shared virtual hand 622-1 and 624-1.

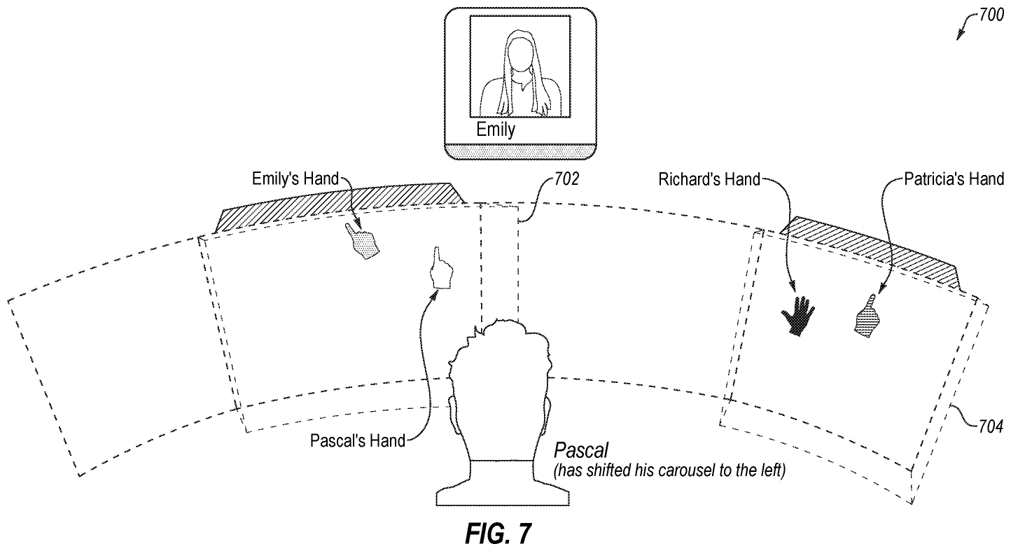

FIG. 7 shows an example of a carousel 700 with shared volume at positions 702 and then position 704 after moving the carousel 700, in accordance with one or more embodiments of a disclosure. In one or more other embodiments, there may be multiple shared volumes, so, for example, there may be a first shared volume at position 702 and a second shared volume at position 704. In one or more embodiments, one or more shared volumes may be activated/deactivated at one or more positions in a presenter's workspace.

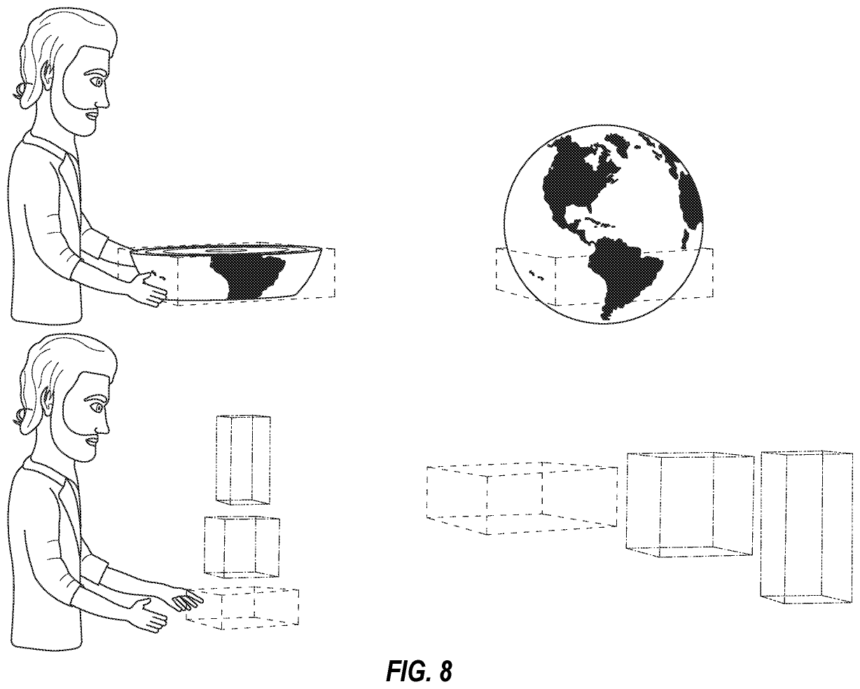

FIG. 8 shows non-limiting expecific examples of various shapes and dimensions of a shared volume, in accordance with one or more embodiments. Moreover, FIG. 8 shows that a shared volume may be placed at a workspace object (i.e., positioned with respect to a workspace object) present in a virtual workspace, and a portion of the workspace object may be shared among presenter and participants via shared volumes.

While in various embodiments business application data is described as sent separately from the shared workspace and shared volume related data, typically managed by the business application. However, the disclosure is not so limited. The workspace and shared volume related data may be provided together with the business application data. Moreover, while the shared workspace session client is shown as a module of the VR workspace application, embodiments are specifically contemplated where the workspace session client is a module of a business application.

While the examples and embodiments have been described with reference to virtual hands, in some cases, a VR engine (such as GearVR, Oculus without Touch, etc.) may not include inputs that respond to or capture hand movement of a user (e.g., 6DOF input devices). In other case, users may not be seated or may have physical disabilities limiting arm and/or hand motion. Accordingly, some embodiments relate, generally, to an interface configured to receive one or more inputs from a gaze capturing hardware device. A gaze pointer is directed a sharing volume in a shared workspace responsive to the gaze information received from the interface. The interpreted location of the gaze may be provided to participants and a pointer or other indicator displayed in the participant shared volume.

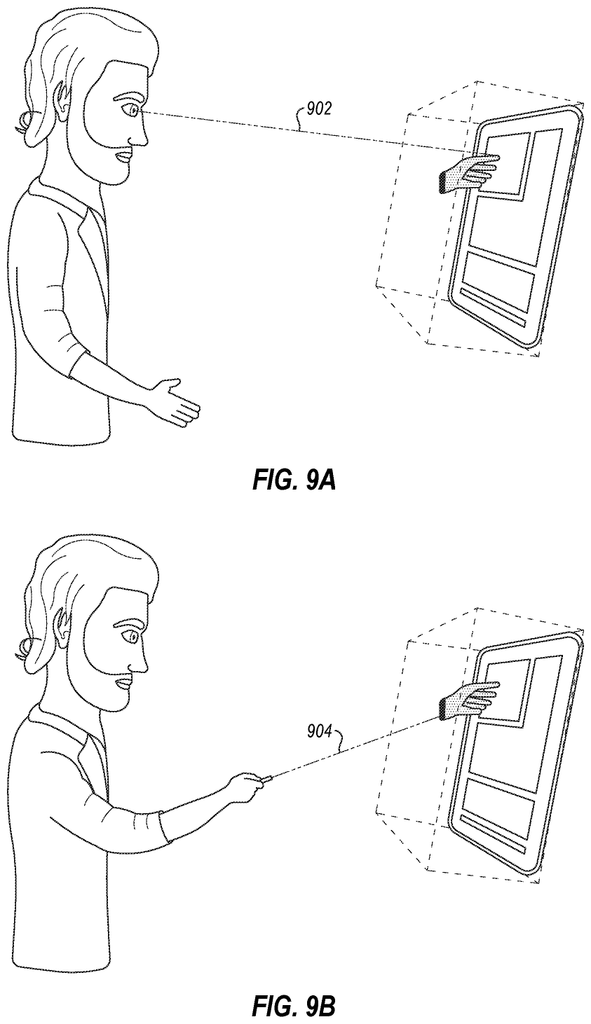

FIG. 9A shows a hand pointer 902 and FIG. 9B shows and a gaze pointer 904 that is provided to a shared volume, in accordance with one or more embodiments of the disclosure. More specifically, FIGS. 9A and 9B show a virtual hand pointer 902 and a virtual gaze pointer 904 provided as virtual input devices by VR engine 220 or VR workspace application 210. So, interaction with a virtual workspace may, in some embodiment, involve use of physical and virtual input devices. Notably, visible lines (also labeled in FIGS. 9A and 9B as part numbers 902 and 904, respectively) are displayed from a beginning (e.g., virtual view point or virtual pointer in virtual hand, without limitation) to a shared display through a shared volume in front of the shared display.

One or more embodiments may be implemented by a general purpose computer configured to perform some or a totality of the features and functions of embodiments discussed herein. As a non-limiting example, VR workspace application 210 and business applications 250 may be executed by a general purpose computer configured to perform or a totality of the features and functions of embodiments discussed herein. A general purpose computer may be a workstation or personal computer physically located with a user, a virtual computer located on a server that a user may interact with via hardware such as a virtual computer, a service provided in a cloud computing environment to a user via hardware such as a personal computer, and combinations thereof. Non-limiting examples of a personal computer include a laptop computer, desktop computer, terminal computer, mobile device (e.g., smart phone, tablet computer, etc.), or wearable computer. A person having ordinary skill in the art would understand that functional modules discussed herein, such as blocks of workspace computing system 200 of FIG. 2, are capable of numerous arrangements without exceeding the scope of this disclosure.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,”, without limitation.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”, without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A method of sharing expressive actions over one or more shared workspace sessions, comprising:
defining a shared volume in a first workspace;
displaying a shared workspace object in the shared volume;
displaying a first virtual hand in the shared volume;
capturing first expressive actions of the first virtual hand at the shared volume; and
providing one or more of the first expressive actions to one or more participants of a shared workspace session.

2. The method of claim 1, wherein capturing the first expressive actions of the first virtual hand comprises: capturing hand motions and hand positions of the first virtual hand displayed at the shared volume.

3. The method of claim 2, wherein capturing the first expressive actions of the first virtual hand comprises: capturing information about a position of the first virtual hand relative to the shared workspace object.

4. The method of claim 1, further comprising displaying a second virtual hand in the shared volume, the second virtual hand corresponding to a virtual hand of a second workspace of the shared workspace session.

5. The method of claim 4, wherein displaying the second virtual hand comprises displaying the second virtual hand having second expressive actions, the second expressive actions corresponding to expressive actions captured at a shared volume of the second workspace.

6. The method of claim 1, further comprising:
controlling the displaying of the first virtual hand responsive to an interface device.

7. The method of claim 1, further comprising:
receiving one or more expressive actions of the one or more participants of the shared workspace session.

8. The method of claim 1, further comprising:
defining shared volumes of workspaces associated with second workspace sessions.

9. The method of claim 8, further comprising:
initiating one of the shared volumes responsive to selecting an associated one of the second workspace sessions.

10. A shared workspace computing system, comprising:
a virtual reality display system configured to be controlled by a virtual reality engine, wherein the virtual reality engine is configured to enable the virtual reality display system to:
display a shared volume in a virtual workspace;
display a shared virtual work object at the virtual workspace; and
display expressive actions of a first virtual hand at the shared volume, and a virtual reality workspace application configured to:
capture the expressive actions of the first virtual hand; and
provide the expressive actions to one or more participants of a shared workspace session.

11. The shared workspace computing system of claim 10, wherein the shared workspace comprises a virtual display.

12. The shared workspace computing system of claim 11, wherein the shared volume is a shared volumetric region defined in front of the display.

13. The shared workspace computing system of claim 10, wherein the virtual reality workspace application is configured to:
receive expressive actions of one or more second virtual hands associated with pariticpations of the shared workspace session.

14. The shared workspace computing system of claim 13, wherein the virtual reality engine is configured to:
display, at the shared volume, the one or more second virtual hands comprising the expressive actions.

15. The shared workspace computing system of claim 10, wherein the virtual reality workspace application is configured to:
define shared volumes of workspaces associated with second workspace sessions.

16. The shared workspace computing system of claim 15, wherein the shared workspace computing system of claim 10, wherein the virtual reality workspace application is configured to:
initiating one of the shared volumes responsive to selecting an associated one of the second workspace sessions.
